(19) United States
(12) Patent Application Publication
(10) Pub. No.: US 2022/0057147 A1
(43) Pub. Date: Feb. 24, 2022

(54) REGENERATOR AND METHOD FOR MANUFACTURING SUCH A REGENERATOR

(71) Applicant: UNIVERSITE DE FRANCHE-COMTE, Besançon (FR)

(72) Inventors: Steve DJETEL-GOTHE, Belfort (FR); Mathieu DOUBS, Vetrigne (FR); Mohamed Said KAHALERAS, Orleans (FR); François LANZETTA, Belfort (FR); Guillaume LAYES, Belfort (FR)

(21) Appl. No.: 17/415,583

(22) PCT Filed: Dec. 17, 2019
(86) PCT No.: PCT/EP2019/085696

§ 371 Date: Jun. 17, 2021

(30) Foreign Application Priority Data
Dec. 20, 2018 (FR) FR1873559

(51) Int. Cl. F28D 17/02; B33Y 80/00; B22F 3/11

(52) U.S. Cl. CPC F28D 17/02; B22F 10/28; B22F 3/1115; B33Y 80/00

(57) ABSTRACT

A single-piece regenerator having at least two portions, at least one of the portions having a porosity which differs from a porosity of an adjacent portion, and each of the portions of the regenerator being made of a porous rigid material with a given porosity.

### TECHNICAL FIELD

The present invention relates to the field of regenerators for devices with external heat input and refrigerating machines.

The present invention relates in particular to a regenerator intended to be used in a Stirling cycle engine or refrigerating machine.

### STATE OF THE PRIOR ART

Regenerators composed of an assembly by stacking of porous discs, such as metallic meshes, placed in contact with one another are known in the state of the prior art. The assembly is inserted in a support, generally a tube, and the elements are gripped and held pressed in the support so as to form the regenerator.

Regenerators produced from micrometric or nanometric fibrous materials, such as pyrolytic graphite or metallic meshes, are also known in the state of the art. These fibrous materials are introduced into a tube, then compressed inside it by application of a given pressure.

The regenerators of the state of the art have the drawback that their porosity and their hydraulic diameter vary over time. The pressure exerted by the gases and the successive expansions of the porous material, due to the elevated temperatures of the gases, bring about structural and geometric alterations of the assembly. In addition, when the regenerators of the state of the art ensure a good heat exchange with the gas, they have small hydraulic diameters bringing about substantial friction losses during the circulation of the gas in the regenerator.

In particular, an aim of the invention is:
to propose a regenerator the porosity of which does not vary over the course of the successive passes of the gases, and/or
to propose a regenerator the hydraulic diameter of which does not vary over the course of the successive passes of the gases, and/or
to propose a regenerator the friction losses of which are small compared with the friction losses of the regenerators of the state of the art, and/or
to propose a regenerator the losses of which due to heat conduction in the direction of circulation of the gases are limited.

### PRESENTATION OF THE INVENTION

To this end, according to a first aspect of the invention, a single-piece regenerator comprising at least two portions is proposed. At least one of the portions has a porosity different from a porosity of a neighbouring portion and each of the portions of the regenerator is produced from a rigid porous material having a given porosity.

The regenerator may comprise only two portions.

A portion can be understood as a part of the regenerator. A portion can be understood as a volume of a part of the regenerator.

The term “neighbouring” can be understood as contiguous.

The portions of the regenerator can be produced from different materials.

The portions of the regenerator can be produced from one and the same material.

By “single-piece” is meant in one piece.

The single-piece regenerator can be obtained by assembling portions together.

Preferably, the single-piece regenerator can be obtained in the course of one and the same manufacturing step.

Preferably, the single-piece regenerator can be manufactured by 3D printing.

Preferably, the single-piece regenerator can be manufactured in one piece from one and the same material by 3D printing.

By rigid material is meant a material which does not deform much under the pressure exerted by gases passing through it.

The material can have a Young's modulus comprised between 20 GPa and 500 GPa.

The porosities of the portions can vary in an alternating or sequential manner.

The porosity can vary in a direction of flow of the gases and/or in a direction normal to the direction of flow of the gases.

The porosity can vary in a direction comprised between the direction of flow of the gases and the direction normal to the direction of flow of the gases.

Given that the flow of the gases within the regenerator is effected in one sense then in the other in the course of one and the same cycle, from a hot part of a device in which the regenerator is integrated to a cold part then from the cold part of said device to the hot part, a direction of flow of the gases is understood only with regard to the direction without considering the sense of flow.

A portion extends between two sections of the regenerator, each of the sections being normal to a direction connecting one end of the regenerator to the other.

A section is understood as being the intersection of a volume by a plane.

The direction connecting one end of the regenerator to the other can be identical to the direction of flow of the gases.

The direction connecting one end of the regenerator to the other can be different from the direction of flow of the gases.

Portions of the regenerator situated at the ends of the regenerator, called end portions, can have a porosity or porosities lower than a porosity, or respectively porosities, of a portion, or respectively portions, situated between the end portions.

The end portions can each have a porosity lower than a porosity of any portion situated between the end portions.

A portion of the regenerator having the highest porosity can be situated between the end portions of the regenerator.

The porosities of the portions of the regenerator can increase from a central plane of the regenerator to the ends of the regenerator, said central plane passing through the centre of the regenerator and being perpendicular to the direction of flow of the gases.

The portions of the regenerator can be arranged symmetrically with respect to the central plane of the regenerator.

The central plane of the regenerator can be comprised within the portion of the regenerator with the highest porosity.

The portion of the regenerator with the highest porosity can have a porosity equal to 1.

Several portions of the regenerator can have a porosity equal to 1.

The porosity can be comprised between 0 and 1 per unit of volume and/or between 0 and 1 per unit of length. The ratio between the porosities of neighbouring portions can be greater than 1.

The rigid porous material can be composed of a group of contiguous cells arranged spatially with respect to one another, one or each of the surfaces of contact of each of the cells with the gas forming an angle comprised between 5° and 85° with respect to the direction of flow of the gases.

Given that the regenerator is in a single piece, by cell is meant an identifiable structure of the regenerator.

The structure can be identifiable by its geometry.

In this case, the term “contiguous” is understood as joined.

The angle that the surface or each of the surfaces of contact of each of the cells with the gas forms with respect to the direction of flow of the gases can vary along the surface or each of the surfaces.

The surface or each of the surfaces of contact of each of the cells with the gas can form an angle comprised between 20° and 70°, preferably between 30° and 60°, with respect to the direction of flow of the gases.

The surface or each of the surfaces of contact of each of the cells with the gas can form an angle of 45° with respect to the direction of flow of the gases.

It is possible for portions of the regenerator not to contain cells.

Each cell can comprise at least four oblong elements extending from the centre of the cell, each of the elements forming an angle comprised between 5° and 85° with respect to the direction of flow of the gases.

The oblong elements can constitute the surface or each of the surfaces of contact of each of the cells with the gas.

The surface or each of the surfaces of contact of each of the oblong elements with the gas can form an angle comprised between 20° and 70°, preferably between 30° and 60°, with respect to the direction of flow of the gases.

The surface or each of the surfaces of contact of each of the oblong elements with the gas can form an angle of 45° with respect to the direction of flow of the gases.

Two contiguous cells can be physically connected together:
by at least one of their oblong elements, or
by a layer of material to which at least one of their oblong elements is connected.

One cell can be connected to at least two contiguous cells.

One oblong element can be connected to several contiguous cells.

The layer of material can separate two contiguous cells.

The layer of material can be flat and continuous.

Preferably, the layer of material extends in the direction of flow of the gases.

Preferably, two contiguous cells can be physically connected together:
by at least two of their oblong elements,
by a layer of material to which at least two of their oblong elements are connected.

The regenerator can comprise two layers of materials.

Preferably, each of the layers of material extends in the direction of flow of the gases.

The regenerator can comprise more than two layers of material.

When the regenerator comprises two layers of material, the two layers can be perpendicular to each other.

By way of non-limitative example, the oblong elements can be a rod, a cone or else a triangle.

The oblong elements of the cells can be symmetrical in twos with respect to one or more planes of symmetry comprising the centre of the cell.

Each cell can comprise a single plane with respect to which all of the oblong elements are symmetrical in twos.

Within one and the same cell, at least two oblong elements can extend from one side of a plane comprising the centre of the cell and being normal to the direction of flow of the gases and at least two other oblong elements can extend from the other side.

One or more cells can comprise two oblong elements extending from one side of a plane comprising the centre of the cell and being normal to the direction of flow of the gases and two other oblong elements extending from the other side. In this case, the cell or cells may comprise only four oblong elements.

All of the cells of the regenerator can be identical.

A cell or cells of the regenerator can comprise eight rods, each forming an angle of 45° with respect to the direction of flow of the gases and forming an angle of 90° with one another within one and the same cell.

The rigid porous material can be a metal, an alloy or a plastic.

A method for manufacturing a device according to the first aspect of the invention by 3D printing is also proposed.

The manufacturing method can be a 3D printing method by powder bed fusion.

The manufacturing method can be a 3D printing method by metal powder bed fusion.

The manufacturing method can be a 3D printing method by laser sintering of metal powders.

### DESCRIPTION OF THE FIGURES

Other advantages and characteristics of the invention will become apparent on reading the detailed description of implementations and embodiments which are in no way !imitative, and from the following attached drawings:

FIG. 1 is a diagrammatic representation of a profile view of a regenerator containing three portions,

FIG. 2 is a diagrammatic representation of a profile view of a regenerator containing six portions,

FIG. 3 is a diagrammatic representation of a cell according to the invention,

FIG. 4 is a diagrammatic representation of an arrangement of cells contiguous in one direction,

FIG. 5 is a diagrammatic representation of a volume of the regenerator comprising contiguous cells connected by a layer of material,

FIG. 6 is a diagrammatic representation of a profile view of a regenerator comprising an alternation of portions with different porosities,

FIG. 7 is a representation of a profile view of a regenerator comprising an alternation of portions containing cells contiguous with one another and portions not containing any cells.

### DESCRIPTION OF THE EMBODIMENTS

As the embodiments described hereinafter are in no way imitative, it is possible in particular to consider variants of the invention comprising only a selection of the characteristics described, in isolation from the other characteristics described (even if this selection is isolated within a sentence comprising these other characteristics), if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

The regenerators are intended to be used within devices in which a circulation of gas between a hot zone and a cold zone occurs. The structural properties of the regenerator are adapted to the conditions of use of the regenerator 1, such as the type of gas passing through it, the temperature of the hot and cold gas passing through it, the pressure of the gas as well as the dimensional constraints imposed by the device in which it is to be integrated.

In general, the performance of the regenerator 1 is linked to its capacity:
to store the heat originating from a hot gas passing through it in a given sense 4 while the temperature and pressure of the latter decrease while it is passing through,
to release, or transfer, the accumulated heat to a cold gas passing through it in the opposite sense 5 while the temperature of the latter increases and its pressure decreases while it is passing through.

The unsteady heat exchanges between the regenerator 1 and the gas passing through it are therefore improved when the exchange surface area of the regenerator 1 is increased. In practice, as the dimensions of the regenerator 1 are fixed, the exchange surface area of the regenerator can be increased by reducing the porosity of the regenerator 1.

However, the reduction in the porosity results in an increase in the frictions losses, i.e. frictions between the gas and the exchange surface of the regenerator 1. These losses can only be compensated for by an increase in the pressure at which the hot gas is injected into the regenerator 1. These losses result in a drop in the thermodynamic efficiency of the device.

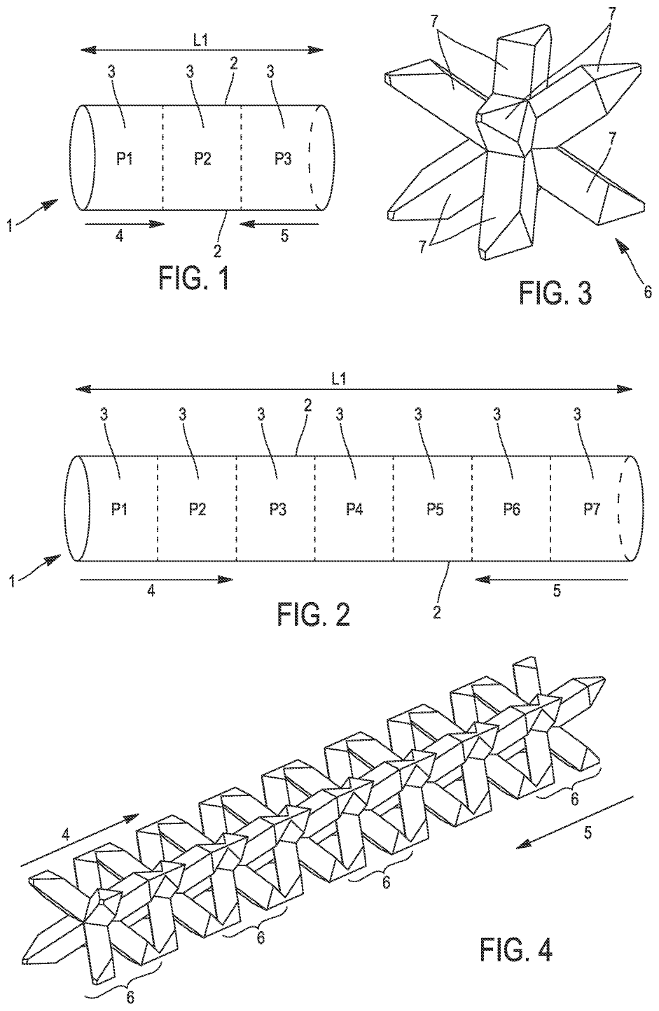

In order to improve the unsteady heat exchanges without increasing the friction losses, a single-piece regenerator 1 comprising volumes with different porosities arranged along the direction of flow of the gases is also proposed. With reference to FIG. 1, in a first aspect of the invention a single-piece regenerator 1 comprising three portions P1, P2 and P3 having porosity values PO1, PO2 and PO3 is described. According to the first aspect of the invention, the regenerator 1, i.e. the walls 2 and the porous material 9 making up the portions 3 (examples of portions are illustrated in FIGS. 3 to 7), is in one piece. The material used is rigid and chosen as a function of the intended use. It has a Young's modulus comprised between 20 and 500 GPa. It must generally be sealed and not chemically reactive with the type of gas circulating in the regenerator and withstand the substantial thermomechanical stresses. The portion P1 is situated on the side of the cold zone of the device and P3 is situated on the side of the hot zone. In the course of a thermodynamic cycle, the gases circulate from the hot zone to the cold zone, and vice versa. The notion of direction of flow also does not imply the notion of sense in the present application.

The fact that the regenerator 1 is of a single piece ensures that the overall porosity and the exchange surface area of the regenerator are preserved over time. The severe stresses, in particular in terms of pressures and temperatures of the gases passing through the regenerator 1, to which the regenerator 1 is subjected bring about an alteration of the porosity and the exchange surface area of the regenerators of the state of the art over time. The expansions and the forces exerted by the hot gas under pressure over the course of the successive cycles gradually alter the structure of the regenerators of the state of the art. Over time, this leads to a reduction in the performance of the regenerators of the state of the art and of the device of which they form part. The single-piece nature of the regenerator 1 according to the invention makes it possible to avoid these effects, which makes it possible for it to preserve a constant porosity and exchange surface area over time. Its performance over time is therefore improved.

The regenerator 1 can be used in any type of device with external heat input, whether it is an engine, for generating electricity for example, or a refrigerator for producing cold. The characteristics of the regenerator 1 are closely linked to the conditions of use for which it is designed.

In order to improve the efficiency of the heat storage/transfer, the regenerator 1 is arranged so that the ends P1, P3 have the lowest porosity values, so as to maximize the heat exchanges at the ends of the regenerator 1. This also makes it possible to maximize the heat storage/transfer in the rigid porous material 9 constituting the parts P1 and P3. This moreover makes it possible to store the majority of the heat in the part of the regenerator 1 situated on the side of the hot zone of the device.

In combination, the introduction of a central part P2 having a porosity value PO2 higher than the porosity values PO1, PO3 of the ends P1, P3 of the regenerator 1 makes it possible to considerably reduce the heat conduction of the regenerator 1 in the sense of flow of the gases. In fact, one of the objectives of the regenerator 1 is to limit the transmission of heat, by the gas, from the hot part to the cold part, and vice versa. Limiting the heat conduction of the regenerator 1 in the sense of flow of the gases thus improves the performance of the regenerator 1 and the yield of the device in which the regenerator 1 is intended to be integrated. This also makes it possible to reduce the friction losses and thus to further improve the efficiency of the regenerator 1.

According to a first variant, the porosity value of PO1 is different from the porosity value PO3. In this case, PO2 can be equal to PO3 or to PO1, or be different from PO3 and PO1. Advantageously, the porosity value PO3 is lower than the porosity value PO1, which is lower than PO2.

The difference in porosity between PO1 and PO3 can, moreover, make it possible to introduce, and to control and/or adjust, a phase difference between the pressure and a throughput of gas, and/or a flow rate profile of the gases.

According to a second variant, which is particularly suitable for the case of the regenerators used in Stirling machines, operating in motor or receiving mode, the porosity value PO1 is equal to PO3, in this case the porosity value O2 is different from the values PO1 and PO3.

In order to further improve the performance of the regenerator 1, with reference to FIG. 2, in a third variant, a single-piece regenerator 1 comprising six compartments P1 to P7 having respective porosity values PO1 to PO7 is described. Apart from the number of compartments detailed in the first and second variants, all of the characteristics of the regenerator according to the first aspect of the invention are shared with the third variant.

This third variant makes it possible to further improve the performance of the regenerator 1 by varying the porosity values from one portion of the regenerator 1 to the other. In fact, as mentioned previously, limiting the heat conduction of the regenerator 1 in the sense of flow of the gases improves the performance of the regenerator 1 and the yield of the device in which the regenerator 1 is intended to be integrated. In addition, this alternation of portions with high and low porosity aims at increasing the overall hydraulic diameter of the regenerator 1 so as to reduce the overall friction losses, while preserving an equivalent exchange surface area. To this end, in the third variant, the portions P1 and P7 have high porosity values PO1 and PO7 which are greater than the porosity values PO2 and PO6 of the portions P2 and P6. The other porosity values PO3, PO4 and PO5 of the respective portions P3, P4 and P5 are defined as a function of the use and of the operating parameters of the device in which the regenerator 1 will be integrated.

In a first preferred mode of the third variant, the porosity value PO1 is equal to PO7 and the porosity value PO2 is equal to PO6. By way of example, the porosity values PO3, PO4 and PO5 can be equal to one another, and greater than, or smaller than, the porosity values PO2 and PO6.

In a second preferred mode of the third variant, the neighbouring portion or portions Pᵢ₊₁ and/or Pᵢ₋₁ of a given portion Pᵢ of the regenerator 1 having a porosity value POᵢ has or have a porosity value or porosity values POᵢ₊₁ and/or POᵢ₋₁ smaller than or greater than POᵢ.

In this second preferred mode of the third variant, the porosity values PO1, PO3, PO5 and PO7 are equal to one another and smaller than the porosity values PO2, PO4 and PO6, which are equal to one another.

In this second preferred mode of the third variant, the porosity values PO1, PO3, PO5 and PO7 are equal to one another and smaller than the porosity values PO2, PO4 and PO6, which can be equal to 1. In this case, the portions P1, P4 and P6 do not contain porous material 9.

The porosity values of the portions are defined as a function of the operating parameters associated with the use for which the regenerator 1 is intended. These operating parameters comprise, among other things, the type of gas, the pressures and temperatures of the gases, as well as the operating frequency of the device in which the regenerator is intended to be integrated. As a function of the required thermal power to be exchanged, the minimum exchange surface area required will also be known. Accordingly, the size of the regenerator 1, the number of portions, the sizes and arrangements of the portions as well as the porosities of the portions will be arranged so that the hydraulic diameter and therefore the friction losses are minimal. In particular, the hydraulic diameter of the flow channels present in the portions with a porosity of less than 1 extending along the regenerator 1 must be decreased in order to maximize the heat exchanges between the gas and the regenerator 1 but small enough not to introduce friction losses that are too great. In practice, the hydraulic diameter of the flow channels is larger than or equal to the thickness of the thermal boundary layer. The hydraulic diameter of the flow channels is smaller than a few times the thickness of the thermal boundary layer. The hydraulic diameter of the flow channels is preferably smaller than or equal to ten times, more preferably smaller than or equal to five times, and even more preferably smaller than or equal to twice, the thickness of the thermal boundary layer.

These parameters are extremely variable depending on the use, thus according to the first aspect of the invention the porosity values PO1 to PO3, or PO1 to PO7, of the portions P1 to P3, or P1 to P7, respectively, can be varied between 0 and 1. Preferably, the porosity value of the portions having a high porosity value will be comprised between 0.8 and X1, while the porosity value of the portions having a low porosity value will be comprised between 0.1 and 0.3.

The porosity can be comprised between 0 and 1 per unit of volume and/or between 0 and 1 per unit of length. The ratio between the porosities of neighbouring portions can be greater than 1.

More preferably, all of the regenerator 1, i.e. the walls 2 and the material making up the portions 3 (see FIGS. 3 to 7), is produced from a single block by metal powder bed fusion and in particular by laser sintering of metal powders. The regenerator 1 is manufactured in one piece in the course of a 3D prototyping. The regenerator 1 can be produced from different materials, which may or may not be metallic. Unlike the regenerators in which the parts are formed separately then assembled together, the homogeneity and the control of the porosity of the regenerator 1 according to the invention, produced from a single block by 3D prototyping, are substantially improved. In addition, the production of the regenerator 1 in one piece, during one and the same manufacturing process, also improves the thermal and mechanical performance of the regenerator 1.

According to a second aspect of the invention, with reference to FIGS. 3, 4 and 5, a particular geometry of the rigid porous material 9 constituting the portions 3 with a porosity of less than 1 of the single-piece regenerator 1 is described. As already mentioned, it is possible for some portions 3 of the regenerator 1 not to contain porous material 9; in this case the porosity of the portions 3 in question is equal to 1. The geometry of the rigid porous material 9 of the regenerator 1 is adapted, in particular, as a function of the operating frequency of the regenerator 1. The geometry will also be defined so that each portion 3 has a given porosity value and a hydraulic diameter that is as small as possible. In practice, the number of portions, the sizes and arrangements of the portions 3 as well as the porosities of the portions 3 are defined as a function of the geometry and of the other operating parameters.

The second aspect of the invention will also relate, in particular, to a regenerator 1 intended to be integrated in a (motor or receiving) Stirling machine. The Stirling machine 1 can fall within an architecture of the alpha, beta or gamma type, or even a combination of these architectures. In the case of regenerators 1, the latter must have a minimum length L1 making it possible to separate the cold part of the Stirling machine from the hot part sufficiently. The dimensions of the regenerator 1 are therefore defined as a function of the dimensioning of the Stirling machine. The regenerator 1 for a beta Stirling engine according to the embodiment has a length L1 of 10 cm at most. The operating frequency of the beta Stirling engine is 50 Hz at most. The working pressures of the gases are of the order of 120 bars and the temperature of the hot gas is of the order of 900° C. No alteration of the porosity or of the hydraulic resistance of the regenerator 1 is observed over time.

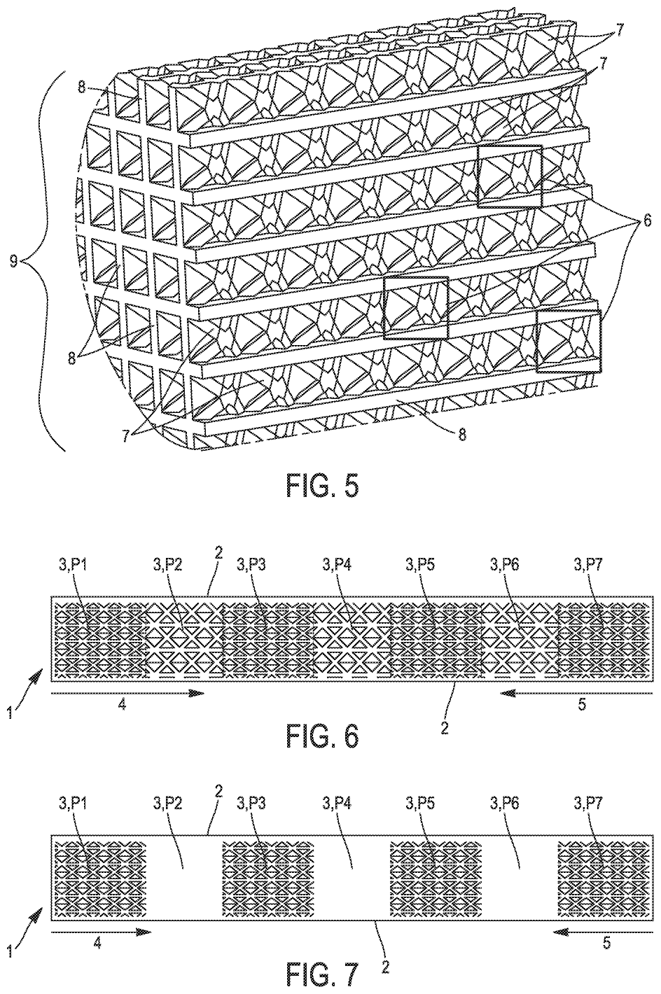

The particular geometry of the rigid porous material 9 shown, in particular in FIG. 5, in the second aspect of the invention can of course be suitable for other uses for which a regenerator 1 can be used.

According to the second aspect of the invention, the rigid porous material 9 of the portions 3 with a porosity of less than 1 is constituted by a group of base cells 6 contiguous with one another. All of the cells 6 of a portion 3 are formed in one piece by metal powder bed fusion in the course of the same 3D prototyping method, illustrated in particular in FIG. 4. By way of example, according to the second aspect of the invention, the regenerator 1 is preferably produced from INOX 316L, for its ability to seal against helium, and its resistance to pressure, to high temperatures, to fatigue and to corrosion.

Each cell 6 of the regenerator 1 comprises eight rods 7 extending from the centre of the cell 6. Each rod 7 of a cell 6 forms an angle of 45° with respect to the direction of flow of the gases. The rods 7 of a cell 6 form an angle of 90° with one another. Thus, each of the rods 7 of each of the cells 6 forms an angle of 45° with respect to the direction of flow of the gases. Advantageously, within one and the same portion 3, the size of the cells 6 is identical. The porosity of each portion 3 comprising the porous INOX 316L 9 is adjusted by altering the size of the cells 6 constituting the portion 3 in question and by altering the length of the portion 3 in question.

Preferably, a flat layer 8 of INOX 316L is introduced between two contiguous cells 6. Each cell 6 is delimited between six layers 8 of INOX 316L which are parallel in twos and form a square, in which the cell 6 in question is inscribed. Each of the layers 8 of INOX 316L extends in the direction of flow of the gases and in one of the two directions perpendicular to the direction of flow of the gases. No angle is formed between the direction of flow of the gases and the layers 8 of INOX 316L. Within the porous structure 9 of INOX 316L of the portions 3 with a porosity of less than 1 of the regenerator 1, each of the four terminal parts of four adjacent rods 7 of one and the same cell 6 is connected to the same layer 8 of INOX 316L. Each terminal part of a rod 7 of a cell 6 is connected to three layers of INOX 316L perpendicular to one another. Within one and the same cell 6, each of the two terminal parts of two rods 7 which are opposite one another with respect to the centre of the cell 6 in question is connected to two parallel layers 8 facing one another.

With reference to FIG. 6, a single-piece regenerator 1 containing seven portions 3 is described. Each portion 3 comprises porous INOX 316L 9 according to the second aspect of the invention. The porosity of each portion 3 comprising porous INOX 316L 9 is adjusted by altering the size of the cells 6 constituting the portion 3. The portions 3 P1, P3, P5 and P7 have a porosity comprised between 0.3 and 0.7. The cells 6 of the portions 3 P1, P3, P5 and P7 have an identical length comprised between 5 mm and 15 mm. The portions 3 P2, P4 and P6 have a porosity comprised between 0.5 and 0.9. The cells 6 of the portions 3 P2, P4 and P6 have an identical length comprised between 5 mm and 15 mm. The portions 3 P1, P3, P5 and P7 have a lower porosity than the portions 3 P2, P4 and P6 and lengths that can be identical.

With reference to FIG. 7, a single-piece regenerator 1 containing seven portions 3 is described. Only the portions 3 P1, P3, P5 and P7 comprise porous INOX 316L 9 according to the second aspect of the invention. The portions 3 P2, P4 and P6 do not comprise porous INOX 316L 9; their porosity is equal to 1. The porosity of the portions 3 P1, P3, P5 and P7 comprising porous INOX 316L 9 is adjusted by altering the size of the cells 6 constituting the portion 3. The portions 3 P1, P3, P5 and P7 have a porosity comprised between 0.3 and 0.9. The cells 6 of the portions 3 P1, P3, P5 and P7 have an identical length comprised between 5 mm and 15 mm. The cells 6 of the portions 3 P2, P4 and P6 have an identical length comprised between 5 mm and 15 mm.

Of course, the invention is not limited to the examples that have just been described, and numerous amendments can be made to these examples without departing from the scope of the invention.

Thus, in variants, which can be combined with one another, of the previously described embodiments:
the porosity of the regenerator 1 varies in a direction normal to the direction of flow of the gases, and/or
the porosity of the regenerator 1 varies in a direction comprised between the direction of flow of the gases and the direction normal to the direction of flow of the gases, and/or
the portions of the regenerator 1 with the highest porosity values describe a coil extending between one end of the regenerator 1 and the other, and/or
a portion of the regenerator 1 with the highest porosity value extends in a coil from one end of the regenerator 1 to the other, and/or
the cells 6 are produced separately individually and are connected to one another in the course of a subsequent assembly process, and/or
the portions 3 are produced separately individually and are connected to one another in the course of a subsequent assembly process.

In addition, the different characteristics, forms, variants and embodiments of the invention can be combined with one another in various combinations, unless they are incompatible or mutually exclusive.

1. A single-piece regenerator comprising: at least two portions, at least one of the portions has a porosity different from a porosity of a neighbouring portion and each of the portions of the regenerator is produced from one and the same rigid porous material having a given porosity; a porosity and an exchange surface area of the regenerator are constant over time and the rigid porous material is composed of a group of contiguous cells arranged spatially with respect to one another; and one or each of the surfaces of contact of each of the cells with the gas forms an angle comprised between 5° and 85° with respect to the flow direction of the gases.

2. The regenerator according to claim 1, in which the porosities of the portions vary in an alternating or sequential manner.

3. The regenerator r according to claim 1, in which the porosity varies in a flow direction of the gases and/or in a direction normal to the direction of flow of the gases.

4. The regenerator according to caim 1, in which a portion extends between two sections of the regenerator, each of the sections being normal to the direction connecting an input of the regenerator to an output.

5. The regenerator according to claim 1, in which portions of the regenerator situated at the ends of the regenerator, called end portions, have a porosity or porosities lower than a porosity, or respectively porosities, of a portion, or respectively portions, situated between the end portions.

6. The regenerator according to claim 5, in which the end portions each have a porosity lower than a porosity of any portion situated between the end portions.

7. The regenerator according to claim 1, in which the porosities of the portions of the regenerator increase from a central plane of the regenerator to the ends of the regenerator, said central plane passing through the centre of the regenerator and being perpendicular to the flow direction of the gases.

8. The genenerator according to claim 7, in which the portions of the regenerator are arranged symmetrically with respect to the central plane of the regenerator.

9. The regenerator according to claim 1, in which the portion of the regenerator with the highest porosity has a porosity equal to 1.

10. The regenerator according to claim 1, in which the porosity is comprised between 0 and 1 per unit of volume and/or between 0 and 1 per unit of length.

11. The regenerator according to claim 1, in which each cell comprises at least four oblong elements extending from a centre of the cell, each of the elements forming an angle comprised between 5° and 85° with respect to the flow direction of the gases.

12. The regenerator according to claim 1, in which two contiguous cells are physically connected together:
by at least one of their oblong elements, or
by a layer of material to which at least one of their oblong elements is connected.

13. The regenerator according to claim 11, in which the oblong elements of the cells are symmetrical in twos with respect to one or more planes of symmetry comprising the centre of the cell.

14. The regenerator according to claim 11, in which, within one and the same cell, at least two oblong elements extend from one side of a plane comprising the centre of the cell and being normal to the flow direction of the gases and at least two other oblong elements extend from the other side.

15. A method for manufacturing the device according to claim 1 by 3D printing.
